(19) United States
(12) Patent Application Publication
(10) Pub. No.: US 2015/0019166 A1
(43) Pub. Date: Jan. 15, 2015

(54) WATER DAMAGE MITIGATION MANAGEMENT SYSTEM AND METHOD

(71) Applicant: Independent Mitigation and Cleaning/ Conservation Network,Inc., Naperville, IL (US)

(72) Inventors: Patrick H. HARMON, Naperville, IL (US); James ANTHONY, Haslett, MI (US); Nathan HART, Naperville, IL (US)

(73) Assignee: Independent Mitigation and Cleaning/Conservation Network, Inc., Naperville, IL (US)

(21) Appl. No.: 13/940,165

(22) Filed: Jul. 11, 2013

(51) Int. Cl. G01M 99/00

(52) U.S. Cl. CPC G01M 99/008
USPC 702/182

(57) ABSTRACT

A water damage mitigation management server includes a transceiver, an electronic data storage, and a processor. The transceiver is operable to transmit and receive communications over at least a portion of a network. The processor is configured to receive and cause to be displayed chamber dimension data, water damage data, and dehumidifier data. The processor is further configured to, using at least the chamber dimension data and the water damage data, calculate and caused to be displayed a required quantity of water to be removed from the chamber over a given period of time. The processor is further configured to determine and cause to be displayed whether the required quantity of water to be removed is greater than, less than, or approximately equal to an expected quantity of water to be removed by the chosen dehumidifier over the given period of time.

### TECHNICAL FIELD

The technical field relates in general to a data processing system that aids in managing water damage mitigation at a water damage site. More specifically, the data processing system accepts inputs from a water damage mitigation contractor with access to the water damage site, and provides relevant information to the contractor related to progress in the water damage mitigation at the site.

### BACKGROUND

Comprehensive claims management systems are known in which insurance adjusters, contractors, and insureds interact to satisfy an insurance claim. Typical functionality of these claims management systems includes establishing benchmarks or goals of a contractor in completing a particular job and monitoring progress in achieving the benchmarks or goals by the contractor, facilitating centralized posting of notes such that each party can view notes of other appropriate parties, facilitating centralized posting of relevant documents and photos, recording and tracking payments, and of course maintaining the full range of identifying information of all the parties.

Although claims management systems have improved claims processing, an equivalent improvement has not been seen in terms of efficiency with which the actual work that is the subject of many insurance claims is performed. Water damage mitigation comprises a substantial portion of contractor work performed in satisfying building owner insurance claims. However previous attempts at an effective water damage mitigation management system have suffered from significant drawbacks such as failing to enable remote processing, failing to ensure adherence to standardized quality measurements, and simply failing to provide management features that significantly impact the work of a water damage mitigation contractor. The presently disclosed water damage mitigation management system corrects these deficiencies, and others, and provides a platform for water damage mitigation contractors to more easily and efficiently complete their water damage mitigation jobs.

### SUMMARY

Accordingly, a first embodiment provides a water damage mitigation management server. The water damage mitigation management server comprises a transceiver, operable to transmit and receive communications, over at least a portion of a network and an electronic data storage. The water damage mitigation management server further comprises a processor cooperatively operable with the transceiver and the electronic data storage.

The processor is configured to receive and cause to be displayed chamber dimension data, including dimensions of one or more rooms in a chamber in which water damage has occurred. The processor is further configured to receive and cause to be displayed water damage data, including a category of water and a class of water. The processor is also configured to receive and cause to be displayed dehumidifier data, including a model type and a rating of a chosen dehumidifier to be used in removing water from the chamber.

The processor is further configured to, using at least the chamber dimension data and the water damage data, calculate and caused to be displayed a required quantity of water to be removed from the chamber over a given period of time. Lastly, the processor is also configured to determine and cause to be displayed whether the required quantity of water to be removed is greater than, less than, or approximately equal to an expected quantity of water to be removed by the chosen dehumidifier over the given period of time.

A second embodiment provides a water damage mitigation management method, implemented in a water damage mitigation management server comprising a transceiver, an electronic data storage, and a processor. The method comprises receiving and causing to be displayed, by the processor, chamber dimension data, including dimensions of one or more rooms in a chamber in which water damage has occurred. The method further comprises receiving and causing to be displayed, by the processor, water damage data, including a category of water and a class of water. The method further comprises receiving and causing to be displayed, by the processor, dehumidifier data, including a model type and a rating of a chosen dehumidifier to be used in removing water from the chamber.

The method further comprises using at least the chamber dimension data and the water damage data, calculating and causing to be displayed, by the processor, a required quantity of water to be removed from the chamber over a given period of time. The method also comprises determining and causing to be displayed, by the processor, whether the required quantity of water to be removed is greater than, less than, or approximately equal to an expected quantity to be removed by the chosen dehumidifier over the given period of time.

A third embodiment provides a non-transitory computer-readable storage medium. The medium has instructions stored thereon. When executed by a sever computer, comprising a transceiver, an electronic data storage, and processor, the instructions cause the server computer to perform the water damage mitigation management method described above.

It should be quickly noted that the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying figures, where like reference numerals refer to identical or functionally similar elements and which together with the detailed description below are incorporated in and form part of the specification, serve to further illustrate various exemplary embodiments and to explain various principles and advantages in accordance with the embodiments.

FIG. 1 is a block diagram illustrating a water damage mitigation management system, including a water damage mitigation management server.

FIG. 2 is a web page screen capture showing water damage mitigation management functionality in general.

FIG. 3 is a web page screen capture showing water damage mitigation management functionality related to drying chambers information.

FIG. 4 is a web page screen capture showing water damage mitigation management functionality related to alternate drying chambers information.

FIG. 5 is a web page screen capture showing water damage mitigation management functionality related to atmospheric readings and dehumidifier readings.

FIG. 6 is a web page screen capture showing water damage mitigation management functionality related to a moisture map and associated water measurements.

FIG. 7 is a block diagram illustrating a water damage mitigation management server configured to implement water damage mitigation management functionality.

FIG. 8 is a flow chart illustrating a water damage mitigation management method.

### DETAILED DESCRIPTION

The instant disclosure is provided to further explain in an enabling fashion the best modes of performing one or more embodiments. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented in a processor, are best supported with or in software or integrated circuits (ICs), such as a digital signal processor and software therefore, and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring principles and concepts, further discussion of such software and ICs, if any, will be limited to the essentials with respect to the principles and concepts used by the exemplary embodiments.

As indicated above, the present disclosure concerns a water damage mitigation management server that is designed to aid a contractor in more easily and efficiently completing a water damage mitigation job. In one embodiment, the water damage mitigation management server is configured in an enterprise network of any scale. That is to say, the water damage mitigation management server would be operated by an enterprise that is responsible for overseeing one or more contractors.

In such an environment, the water damage mitigation management server would be accessible either at the server itself, or through an enterprise network client device. It is envisioned that water damage mitigation management server is intended to be operated either self-sufficiently, through an operator who is employed by, or responsible to, the enterprise, or even by a contractor.

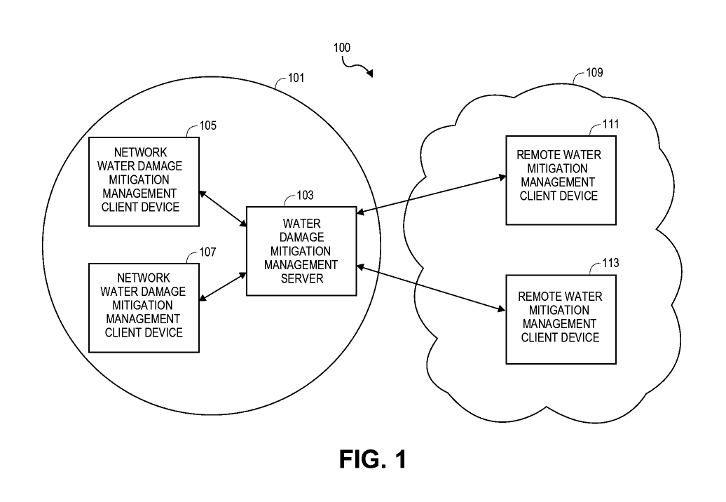

Referring then to FIG. 1, a block diagram illustrating a water damage mitigation management system 100 is discussed and described. The water damage mitigation management system 100 includes an enterprise network 101 and a remote network 109. In an exemplary embodiment, the enterprise network 101 includes a water damage mitigation management server 103 and one or more network water damage mitigation management client devices 105, 107.

As mentioned above, the water damage mitigation management server 103 may be operated by an enterprise which oversees one or more contractors, and provides resources for operation of the enterprise network 101. While much of the functionality of the water damage mitigation management server 103 is performed autonomously in response to input from remote water damage mitigation management client devices 111, 113, it should be understood that network administrators and other employees of the enterprise program and operate the water damage mitigation management server 103. Thus the water damage mitigation management server 103 and the network water damage mitigation management client devices 105, 107 may each be communicable with the other over a local area network (LAN), or if the enterprise is large enough, a wide area network (WAN).

Of course, the water damage mitigation management server 103 operates to aid water damage mitigation contractors in efficiently and easily completing their water damage mitigation jobs. Thus it should be expected that the water damage mitigation management server 103 will communicate with remote water damage mitigation management client devices 111, 113. Succinctly put, almost all of the relevant information that needs to be collected in order to manage and facilitate completion of a water damage mitigation job needs to be collected at a remote site of the water damage.

The water damage mitigation management server 103 is therefore designed to be able to communicate remotely with on-site devices, illustrated in FIG. 1 as remote water damage mitigation management client devices 111, 113. Generally speaking, all reading and measurements can be uploaded from the job site with any smart device with Internet connectivity, as discussed further below. Complimentary wise, calculated and/or supplied data from the water damage mitigation management server 103 may be provided back to a remote device using the Internet, as discussed further below. Significantly more detail related to the water damage mitigation management system 100 and its components is now provided.

Each of the water damage mitigation management server 103, the network water damage mitigation management client devices 105, 107, and the remote water damage mitigation management client devices 111, 113 may be viewed as a computer system. As described above, the computer systems 103, 105, 107 in one embodiment may communicate over an enterprise network, however in other embodiments the computer systems 103, 105, 107, 111, 113 may communicate each with the other over any network such as the Internet, an intranet, or any other network. Each computer system 103, 105, 107, 111, 113 may be programmed to operate in automated fashion, and may also have an analog or a graphic user interface such as Outlook and Windows such that users can control computer systems 103, 105, 107, 111, 113. Each computer system 103, 105, 107, 111, 113 may include at least a central processing unit (CPU) with data storage such as disk drives, the number and type of which are variable. In each computer system 103, 105, 107, 111, 113, there might be one or more of the following: a floppy disk drive, a hard disk drive, a solid state drive, a CD ROM or digital video disk, or other form of digital recording device.

Each computer system 103, 105, 107, 111, 113 may include one or more displays upon which information may be displayed. Input peripherals, such as a keyboard and/or a pointing device, such as a mouse, may be provided in each computer system 103, 105, 107, 111, 113 as input devices to interface with each respective CPU. To increase input efficiency, the keyboard may be supplemented or replaced with a scanner, card reader, or other data input device. The pointing device may be a mouse, touch pad control device, track ball device, or any other type of pointing device.

Each computer system 103, 105, 107, 111, 113 may interconnects peripherals previously mentioned herein through a bus supported by a bus structure and protocol. The bus may serve as the main source of communication between components of each computer system 103, 105, 107, 111, 113. The bus in each computer system 103, 105, 107, 111, 113 may be connected via an interface.

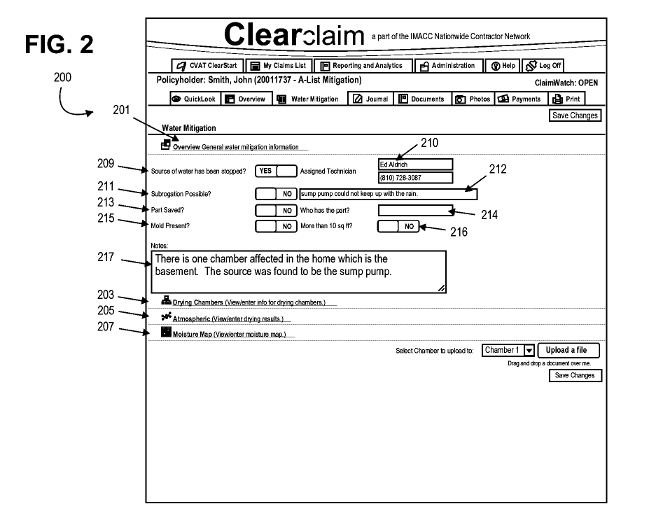

The CPU of each computer system 103, 105, 107, 111, 113 may perform the calculations and logic operations required to execute the functionality of each computer system as described in this disclosure and as illustrated in FIGS. 2-6. The functionality of each computer system 103, 105, 107, 111, 113 may be processed in an automated fashion such that relevant data is processed without user administrator assistance or intervention. Alternatively or additionally, the functionality of each computer system 103, 105, 107, 111, 113 may be processed in a semi-automatic fashion with intervention from a user administrator at one or more of the computer systems 103, 105, 107, 111, 113. Implementing, processing, and executing the functionality of each computer system 103, 105, 107, 111, 113 as described in this disclosure with respect to FIGS. 2-6 is within the purview and scope of one of ordinary skill in the art, and is not discussed in detail herein.

Each computer system 103, 105, 107, 111, 113 may be implemented as a distributed computer system or a single computer. Similarly, each computer system 103, 105, 107, 111, 113 may be a general purpose computer, or a specially programmed special purpose computer. Moreover, processing in each computer system 103, 105, 107, 111, 113 may be controlled by a software program on one or more computer systems or processors, or could even be partially or wholly implemented in hardware. The computer systems 103, 105, 107, 111, 113 used in connection with the functionality described with reference to FIGS. 2-6 may rely on the integration of various components including, as appropriate and/or if desired, hardware and software servers, database engines, and/or other content providers.

Although the computer systems 103, 105, 107, 111, 113 in FIG. 1 are illustrated as being a single computer, each computer system according to one or more embodiments of the invention is optionally suitably equipped with a multitude or combination of processors or storage devices. For example, each computer illustrated in computer systems 103, 105, 107, 111, 113 may be replaced by, or combined with, any suitable processing system operative in accordance with the principles of embodiments of the present disclosure, including sophisticated calculators, hand-held smart phones, smartpads, laptop/notebook, mini, mainframe and super computers, as well as processing system network combinations of the same. Further, portions of each computer system 103, 105, 107, 111, 113 may be provided in any appropriate electronic format, including, for example, provided over a communication line as electronic signals, provided on floppy disk, provided on CD-ROM, provided on optical disk memory, etc.

Any presently available or future developed computer software language and/or hardware components can be employed in the computer systems 103, 105, 107, 111, 113. For example, at least some of the functionality mentioned above could be implemented using Visual Basic, C, C++ or any assembly language appropriate in view of the processor being used. It could also be written in an interpretive environment such as Java and transported to multiple destinations to various users.

It is likely that one or more the computer system 103, 105, 107, 111, 113 may be implemented on a web based computer, e.g., via an interface to collect and/or analyze data from many sources. User interfaces may be developed in connection with an HTML display format, XML, or any other mark-up language known in the art. It is possible to utilize alternative technology for displaying information, obtaining user instructions and for providing user interfaces.

As indicated above, each computer system 103, 105, 107, 111, 113 may be connected over the Internet, an Intranet, or over a further network. Links to any network may be a dedicated link, a modem over a POTS line, and/or any other method of communicating between computers and/or users.

Each computer system 103, 105, 107, 111, 113 may store collected information in a database. An appropriate database may be on a standard server, for example, a small Sun™ Sparc™ or other remote location. The information may, for example, optionally be stored on a platform that may, for example, be UNIX-based. The various databases may be in, for example, a UNIX format, but other standard data formats may be used. The database optionally is distributed and/or networked. Succinctly put, the computer systems 103, 105, 107, 111, 113 of the water damage mitigation management system 100 may implement the functionality of the various embodiments described herein with respect to FIGS. 2-6 using any imaginable computing environment.

Turning now to FIG. 2, a web page screen capture showing water damage mitigation management functionality, produced by a water damage mitigation management server, in overview, is discussed and described. Specifically, FIG. 2 illustrates a web page 200 that is an introductory web page that demonstrates the various functionality of the water damage mitigation management server. The web page 200 shows an overview 201 of water damage mitigation management information. For example, the overview 201 includes an indication 209 of whether the source of the water damage has been stopped. This is of course an important determination as it effects how quickly a water damage mitigation contractor must be dispatched. The overview 201 of water damage mitigation management information further includes an indicator 210 of a technician assigned to the job, along with contact information of the technician. This provides for easy contact if necessary.

The overview 201 of water damage mitigation management information further includes an indication 211 of whether subrogation is possible. Subrogation of course is the right of an insurance company to “step into the shoes” of an insured (property owner) in order to seek collection from a negligent third party. In a water damage mitigation situation, the indication 211 addresses whether a property-owner insured can subrogate rights against a negligent third party in order that the third party would be forced to pay for the cost of the water damage mitigation.

The subrogation determination 211 may also include a preliminary determination 212 as to the reason for the water damage. The preliminary determination 212 is generally used to explain why subrogation is not possible. It should be noted that irrespective of any other reason, it is not uncommon for a property-owner insured to have waived his or her subrogation rights through a subrogation waiver clause. The indication 211 of subrogation rights may or may not take into account a subrogation waiver clause.

The overview 201 of water damage mitigation management information further includes a determination 213 of whether a part that may have played a role in the water damage has been saved. If the determination 213 is that the part which played a role in the water damage has been saved, the overview 201 includes an indication 210 of which person has possession of the part. This determination 213 that a part has been saved may be important if subrogation is going to be sought.

The overview 201 of water damage mitigation management information further includes an indicator 215 of whether mold is present in the water-damaged building. If it is indicated that there is mold present, the overview 201 of water damage mitigation management information may further provide a determination 216 of whether the mold extends in an area that is greater than 10 square feet. The overview 201 of water damage mitigation lastly includes a notes area 217 that is provided for a user to input information of particular importance, such as the source of the water damage.

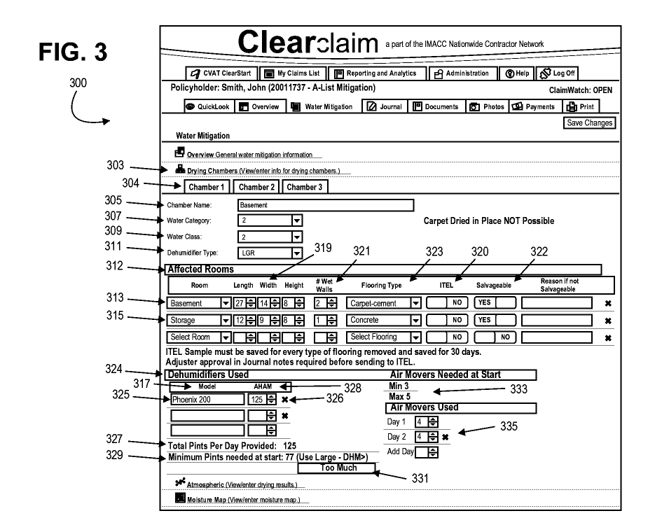

The web page 200 is the base page for all the water damage mitigation management functionality. While the overview 201 of the water damage mitigation management information is general information that relates to a presenting problem of water damage, the information provided by tabs for drying chamber information 203, atmospheric information 205, and a moisture map 207 lead to much more detailed functionality. Thus, when the tab for drying chamber information 203 is selected, the web page 300 in FIG. 3 opens that provides much more detailed information about the various rooms (that is chambers) that are undergoing water damage mitigation.

Turning then to FIG. 3, a web page screen capture showing water damage mitigation management functionality related to drying chambers information is discussed and described. More particularly web page 300 breaks down drying chambers information 303 into identifying and damage information 304, affected room information 312, and remedial measures (dehumidifier) information 324. The identifying and damage information 304 includes for each affected chamber, a chamber name 305, the category 307 of water (type of water) in a damage area, the class 309 of water (defining a type of damage that occurred), and a type of dehumidifier 311 that will be used in removing water and water vapor.

The chamber name 305 is a common nomenclature that identifies a particular chamber in a building in which water damage has occurred. Examples of such nomenclature include basement, kitchen, bedroom, etc. These chamber identifiers can be input either manually or can be selected from a drop down menu.

For each chamber where there is water damage, the type and extent of the damage must be determined. Such a determination is made by a contractor according to industry developed standards. In the water damage mitigation field, these standards are established by the certification and standard-setting non-profit organization known as Institute of Inspection, Cleaning and Restoration Certification (IICRC). Specifically, the IICRC has promulgated the S-500 Standard and Reference Guide for Professional Water Damage Restoration (“S-500 standard”).

For example, in each affected chamber a water damage mitigation contractor must indicate a category 307 of water in the damaged area. However, a category 307 of water is not a general expression. As used in this disclosure, “category of water” is defined in the manner provided by IICRC's S-500 standard. The expression “category of water” and “water category” should be understood to be interchangeable.

The S-500 standard provides 3 different categories of water. Category 1 water is described as “clean water,” and originates from a source not posing substantial harm to humans.

Category 2 water is described as “gray water,” and has a significant level of contamination that can cause sickness or discomfort if consumed by or exposed to humans. Category 3 water is described as “black water,” and is grossly unsanitary and can contain pathogenic, toxigenic, or other harmful agents and can cause severe illness or death. Category 3 water includes sewage, toilet back up, flooding, ground water, or any water which may carry organic matter, pesticides, regulated materials, or other toxic substances.

It should be noted that clean water can become gray water or black water due to a variety of factors including contact with building materials, soils, contaminates or simply if left untreated for certain durations of time and at given temperatures. Further, gray water can become black water if left untreated for 48 hours or more. The water damage mitigation contractor must assess a water category 307 from among the three categories above, and indicated the results in web page 300.

As mentioned above, the identifying and damage information 304 also includes a class 309 of water determination. However as with water category 307, water class 309 is also not used generally. As used in this disclosure, “class of water” is also defined in the manner provided by IICRC's S-500 standard. The expressions “class of water” and “water class” should be understood to be interchangeable. The S-500 standard provides four water class designations.

Class 1 water is where damage is confined to a small area. For example, part of the carpet may be wet with very limited or no wicking up the walls. Only flooring is affected, and damage is to mostly non-porous materials. Class 1 water is characterized by requiring the least amount of absorption and evaporation for remediation.

Class 2 water is where water has affected an entire room of carpet and cushion and wicked up the walls 12 to 24 inches. Class 2 water is characterized by requiring a large amount of absorption and evaporation for remediation. Class 3 water is water that may have come from above. Ceiling, walls, insulation, carpet and pad, and subfloor are all saturated. Class 3 water requires the largest amount of absorption and evaporation for remediation.

Class 4 water is water that requires specialty drying. Specifically, class 4 water is found in hardwood, brick, plaster, stone, crawl spaces, and concrete. Class 4 water requires very low grain air to be used in removal, as is known in the art. Longer drying times and specialty drying equipment is often necessary in remediation of class 4 water. The water damage mitigation contractor must assess a water class 309 from among the four classes described above, and indicate the results in web page 300

Based on the category and class of water, the water damage mitigation contractor will determine which type of dehumidifier should be used in a particular chamber. There are three types of dehumidifiers that can be selected for a water removal in a particular chamber. The first type of dehumidifier is a standard refrigerant dehumidifier which operates when ambient conditions are in a range of 70° to 90°. The standard refrigerant dehumidifier will lose efficiency below a specific humidity of 55 gpp. However, the standard refrigerant dehumidifier is OK for a higher humidity, with wet porous materials. An example of a standard refrigerant dehumidifier is the Ebac Konpact

The second type of dehumidifier is low grain refrigerant (LGR) dehumidifiers. The LGR dehumidifier works best when ambient conditions are between 70° to 90°, however, a high temperature LGR dehumidifier will work in temperatures up to 115°. The LGR dehumidifier removes waver vapor below 40 gpp. An example of an LGR dehumidifier is the Phoenix 200.

The third type of dehumidifier is the desiccant dehumidifier. The desiccant dehumidifier is a specialty dehumidifier used to provide the lowest specific humidity (gpp) and vapor pressure. The desiccant dehumidifier creates dry desert like air and is commonly used for hardwood, books, electronics, and large loss situations. Examples of the desiccant dehumidifier include the Phoenix D385 and the DriEaz 150.

Thus the water damage mitigation contractor must also indicate in web page 300 the dehumidifier type 311. The dehumidifier type 311 may be selected from a drop down menu provide water damage mitigation management server 103 or may be entered free-form by the water damage mitigation contractor. The identifying and damage information 304, including the water category 307, water class 309, and dehumidifier type 311, are selected for each chamber 305 that has experienced water damage in order to aid in determining how much water can be removed in a given day from the chamber.

The identifying and damage information 304 is not alone sufficient to reach determinations related to the time and number of dehumidifiers (or other remedial measures) required for water removal. Specifically, affected room information 312 must also be taken into consideration. The affected room information 312 includes length, width and height information 319, as well as the number of wet walls 321 and the flooring type 323.

Thus as seen in exemplary web page 300, an affected basement 313 is 27 feet long, 14 feet wide, and 8 feet tall. The affected basement 313 has 2 wet walls, and has carpet on cement flooring. In web page 300, an affected storage room 315 is 12 feet long, 9 feet wide, and 8 feet tall. The affected storage room 315 has 1 wet wall, and has concrete flooring.

It should also be quickly noted that the affected room information 312 further includes an ITEL indicator 320 which established whether a sample of the flooring (or any other damaged section of the chamber for that matter) has been collected to be sent to the Florida-based ITEL (Independent Testing and Evaluation Laboratory) Labs for analysis. ITEL will determine product matches, measured specifications and contact information to aide in the process purchasing replacement products for repair. It should be noted that a salvage indicator 322 additionally shows whether the flooring is salvageable, and if not, why not.

As mentioned above, the water damage mitigation contractor must determine the appropriate dehumidifier type 311 to use in a particular chamber given the water category 307 and the water class 309. Once the dehumidifier type 311 is determined, the actual dehumidifiers used 324 are decided. Specifically, the particular model 317 of dehumidifier must be decided and its rating 328 from the Association of Home Appliance Manufacturers (“AHAM rating”) determined. The AHAM rating is the number of pints of water a dehumidifier is able to remove in a 24 hour period of time, in a controlled environment of 80° F. and 60% relative humidity.

In web page 300, the water damage mitigation contractor has selected the particular model 325 “Phoenix 200” as the LGR dehumidifier. The “Phoenix 200” has a particular AHAM rating of 125. Once a particular model of dehumidifier and its respective AHAM rating are indicated for a given water damage mitigation job, an analysis may be performed by the water damage mitigation management server 103 related to whether the selected dehumidifier, for a particular chamber, provides too much water removal, too little water removal, or approximately the right amount of water removal. Stated another way, the water damage mitigation management server 103 calculates whether more or less dehumidifiers are needed, or whether the number in use is appropriate.

The water damage mitigation management server 103 uses the provided identifying and damage information 304, along with the affected room information 312, to calculate the minimum pints 329 needed at the start of water damage mitigation. The minimum pints 329 needed at start is compared with the total pints per day 327 provided by the particular model 325 of dehumidifier. A sufficiency determination 331 can then be easily seen as to whether a particular model 317 provides “too much” dehumidification or whether there is “more needed.” It should be noted that the minimum pints 329 needed at start also includes a correct size of dehumidifier that a water damage mitigation contractor may appropriately charge for, with respect to insurance constraints.

Thus for example, and with respect to the “basement,” the water damage mitigation management server 103 calculates that 77 pints are the minimum pints needed at start. This calculation is based on all the collected identifying and damage information 304 and affected room information 312. The 125 total pints 327 provided by the Phoenix 200 is clearly greater than the 77 pints needed at start. Based on this information, the selected dehumidifier 317 could be replaced.

It should be noted that the water damage mitigation management server 103 also calculates, and displays on web page 300, the number of air movers 333 needed at start. The calculation of the number of air movers 333 needed at start is also based on the collected identifying and damage information 304 and affected room information 312. The water damage mitigation management server 103 further records, and displays on web page 300, the actual number 335 of air movers used on each day of water removal as reported by the water damage mitigation contractor.

As discussed above, the minimum pints needed 329 at start to be removed by the dehumidifier and the number of air movers 333 needed at start are determined based on the several factors that comprise both the identifying and damage information 304 and the affected room information 312. The dimensions of the room are of course a factor to consider. This can easily be seen by comparing calculations returned from analyses of rooms of the same type but having different dimensions.

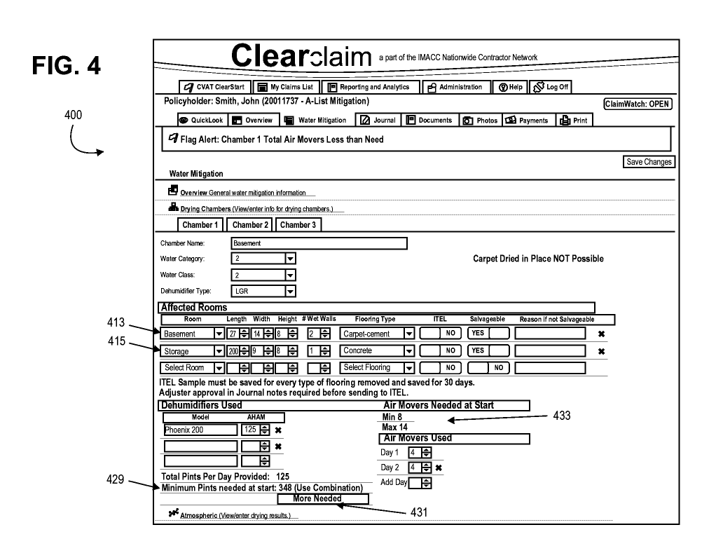

For example, the web page 300 demonstrates that a chamber that includes a basement 313 and a storage room 315 with the dimensions discussed above has a minimum pints requirement at start of 77 pints. As well, anywhere form 3-5 air movers are needed at start. FIG. 4 is a web page screen capture showing water damage mitigation management functionality related to alternate drying chambers information.

The web page 400 illustrates a chamber with a basement 413 that is of the same dimension as in FIG. 3. The only difference between the chamber presented in web page 300 in FIG. 3 and the chamber presented in web page 400 in FIG. 4 is that the dimensions of the storage room 415 are different. Specifically, storage room 415 is 200 feet long, 9 feet wide, and 8 feet tall. It should be noted that the length of the storage room 415 has been exaggerated for illustrative purposes.

Web page 400 demonstrates that with the much longer storage room, the minimum pints 429 needed at start is 348. This is obviously much higher than the 77 pints needed with the smaller storage room presented in web page 300. As total pints per day has not changed from the use of a Phoenix 200, a sufficiency determination 431 produced by the water damage mitigation management server 103 is that more dehumidification and dehumidifiers are necessary. Because of the functionality of the water damage mitigation management server, the water damage mitigation contractor can further add another, or possibly two more, dehumidifiers. The contractor could further remotely indicate which additional dehumidifiers are added, and the water damage mitigation management server will appropriately adjust total pints provided per day.

It should be noted that the water damage mitigation management server also indicates that the air movers 433 needed at start has increased from a range of 3-5 to a range of 8-14. The water damage mitigation contractor will of course use this information to adjust the actual number of air movers being used. Operation of the water damage mitigation management server 103 is dynamic to account for changes in remediation equipment. The water damage mitigation management server 103 aides the water damage mitigation contractor in optimizing dehumidifiers and air movers in order to remedy the water damage as quickly as possible in accord with industry standards.

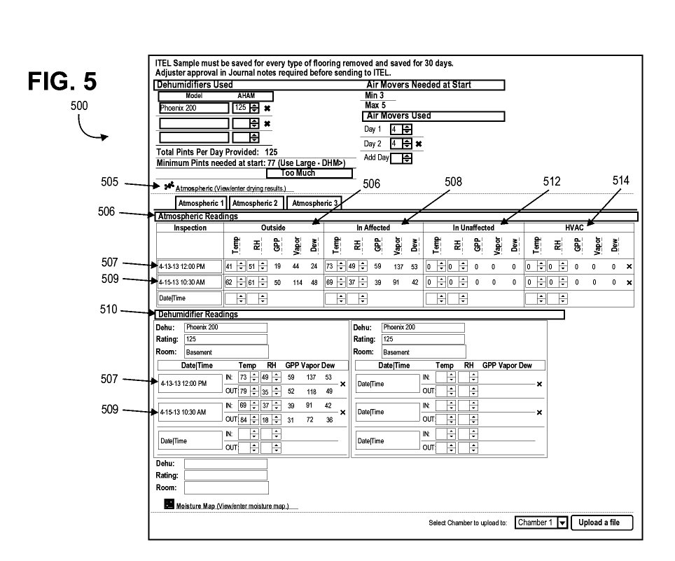

The water damage mitigation management server also aids in recording and utilizing various atmospheric readings. Thus FIG. 5, which is web page screen capture showing water damage mitigation management functionality related to atmospheric readings and dehumidifier readings, is discussed and described. Specifically, FIG. 5 demonstrates a web page 500 that opens when the atmospheric tab 205 in FIG. 2 is selected. More precisely, the web page 500 in FIG. 5 is an extension of web page 300 in FIG. 3, where both the drying chambers tab 203 in FIG. 2 and the atmospheric tab 205 in FIG. 2 are selected to be open.

As is known in the art, measurements of atmospheric reading are useful in determining progress in water damage mitigation. Generally speaking, the water damage mitigation contractor wants to note decreasing water content in ambient air as remedial measures are undertaken. However, measurements are also taken to ensure that water vapor is being contained from entering previously unaffected areas. Additionally, atmospheric measurements ensure that too much water is not being removed.

Web page 500 allows for atmospheric readings 506 to be taken and calculated. Readings are taken at particular cycles, for example, every day or every other day. It should be noted that atmospheric readings are taken at four locations: outside 506 of the building having water damage; in an affected area 508 of the building with water damage; in an unaffected area 512 of the building (that is, inside the building but in an area without damage); and inside an HVAC unit 514. Web page 500 shows a first set of readings 507 that occur on Apr. 13, 2013 at 12:00 PM.

Thus at the first set of readings 507 for each of the outside area 508 and the affected area 512, a reading of temperature (TEMP) is taken, as is a reading of relative humidity (RH). It should be noted that in FIG. 5, readings are not detailed at the unaffected area 512 and in the HVAC 514. This may reflect that for some particular reasons, the water damage mitigation contractor on site did not obtain readings in these areas. Nonetheless, as a general principle readings are taken for an unaffected area 512 and in the HVAC 514 in addition to outside 506 and in an affected area 508.

As is known in the art, relative humidity is the amount of moisture the air is holding at the current temperature compared to the maximum amount the air could hold at that temperature before reaching the saturation point. The measurements of temperature and relative humidity are taken by the water damage mitigation contractor with measuring devices known in the art.

Once the measurements of temperature and humidity are taken, the specific humidity the actual vapor pressure, and the dew point are calculated by the water damage mitigation management server. As is known in the art, the specific humidity is the weight of water vapor in a pound of air, and is measures as grains per pound of air, or “gpp.” Actual vapor pressure is the pressure exerted by water vapor in the atmosphere and is usually expressed in inches of mercury. Lastly, dew point is when relative humidity reaches 100% and is at saturation.

As mentioned above, the water damage mitigation management server will calculate specific humidity, actual vapor pressure, and dew point at each of the outside area 508, affected area 512, unaffected area 515, and in the HVAC 514 based on the measured temperature and relative humidity readings. These values are important to the water damage mitigation contractor as they provide information as to whether remediation measures are working.

It should be noted that a second atmospheric reading 509 is also displayed in the web page 500. The second atmospheric reading 509 indicates that there is more water in the outside air (that is, it may be closer to raining) than at the first reading 507 as all the indicators (relative humidity, specific humidity, actual vapor pressure, and dew point) are higher. However, in the affected area 508, all indicators (relative humidity, specific humidity, actual vapor pressure, and dew point) are lower than in the first reading 507. Thus is appears that the water damage mitigation contractor's efforts are working.

Moisture readings are also taken at the dehumidifier and provided by the dehumidifier. That is to say, the dehumidifier has built-in functionality for providing readings without any external meter or device. The dehumidifier readings 510 are the same as those taken outside 506, in an affected area 508, in an unaffected area 512, and in the HVAC 514. That is to say, the first set of reading 507 taken at, and provided by the dehumidifier, includes measurements of temperature and relative humidity at the situs of the dehumidifier. As well, the second set of readings 509 taken at, and provided by the dehumidifier, includes measurements of temperature and relative humidity at the situs of the dehumidifier. It should be noted, however, that the first and second readings 507, 509 taken at the dehumidifier include “in” and “out” readings that are taken in a single day. As would be expected, the “out” readings reflect that water has been removed from the ambient air as a dehumidifier takes effect.

Succinctly put, the recording and calculations of various measures of water in the ambient air aids a water damage mitigation contractor in determining effectiveness of remediation efforts. Additionally the contractor can make necessary adjustments in order to ensure that water removal is performed according to industry standards. Of course, while measurements of water content in the ambient air are necessary, so too are measurements of water in the affected part of a building, such as the walls, floors and ceiling, carpets, etc.

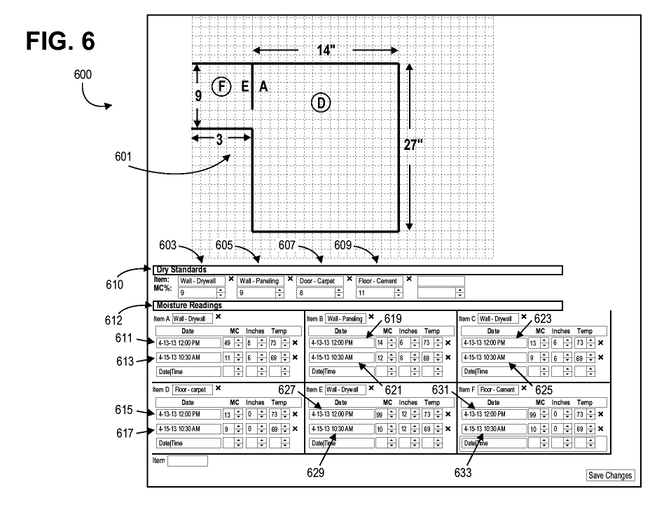

Therefore FIG. 6, which is a web page screen capture showing water damage mitigation management functionality related to a moisture map and associated water content, is discussed and described. Specifically, web page 600 is a portion of a web page that would open upon selection of a moisture map tab 207 in FIG. 2. The web page 600 displays a moisture map 601 which illustrates the various walls and floors of a chamber. The map 601 shows four walls affected by water damage (A, B, C, and E) in a particular chamber. Additionally, floors D and F are also affected by water damage.

The water damage mitigation contractor will ultimately know when his remediation efforts are working by determining whether the moisture content in affected walls and floors has receded from an abnormal level to a normal level. The contractor must therefore initially note the dry standards for each type of wall and floor. In webpage 600, the standard drywall moisture content 603 is indicated to be 9%. The standard paneling moisture content 605 is indicated to also be 9%. The standard carpet moisture content 607 is indicated to be 8%, and the standard cement floor moisture content 609 is indicated to be 11%. The standard moisture content percentages above may be provided by the water damage mitigation management server 103 (in response to indicated types of affected areas), or may simply be input by a water damage mitigation contractor in a data field in the web page 600.

With the dry standards 610 in place, the moisture readings 612 can be uploaded by the contractor to the water damage mitigation management server. Thus first reading 611 of drywall A (on Apr. 13, 2013 at 12:00 PM) shows the moisture content (MC) at 49% when taken 6 inches above ground at 73° temperature. Thus second reading 613 of drywall A (on Apr. 15, 2013 at 10:30 AM) shows MC at 11% when taken 6 inches above ground at 69° temperature. It is clear that the remediation effort is extracting water from the drywall A as the MC transitions from 49%, thru 11%, toward the standard 9%.

The first reading 619 of wall paneling B (on Apr. 13, 2013 at 12:00 PM) shows the MC at 14% when taken 6 inches above ground at 73° temperature. The second reading 621 of wall paneling B (on Apr. 15, 2013 at 10:30 AM) shows MC at 12% when taken 6 inches above ground at 69° temperature. It is clear that the remediation effort is extracting water from the wall paneling B as the MC transitions from 14%, thru 12%, toward the standard 9%.

The first reading 623 of drywall C (on Apr. 13, 2013 at 12:00 PM) shows the MC at 13% when taken 6 inches above ground at 73° temperature. The second reading 625 of drywall C (on Apr. 15, 2013 at 10:30 AM) shows MC at 9% when taken 6 inches above ground at 69° temperature. It is clear that the remediation effort is extracting water from the drywall C as the MC has transitioned from 13% to the standard 9%.

The first reading 615 of floor carpeting D (on Apr. 13, 2013 at 12:00 PM) shows the MC at 13% at ground level at 73° temperature. The second reading 617 of floor carpeting D (on Apr. 15, 2013 at 10:30 AM) shows an MC at 9% at ground level at 69° temperature. It is clear that the remediation effort is extracting water from the floor carpeting D as the MC transitions from 13%, thru 9%, toward the standard 8%.

The first reading 627 of drywall E (on Apr. 13, 2013 at 12:00 PM) shows the MC at 99% when taken 12 inches above ground at 73° temperature. The second reading 629 of drywall E (on Apr. 15, 2013 at 10:30 AM) shows an MC at 10% when taken 12 inches above ground at 69° temperature. It is clear that the remediation effort is extracting water from the drywall E as the MC transitions from 99% (almost complete saturation), thru 10%, toward the standard 9%.

The first reading 631 of cement flooring F (on Apr. 13, 2013 at 12:00 PM) shows the MC at 99% (almost complete saturation) at ground level at 73° temperature. The second reading 633 of cement flooring F (on Apr. 15, 2013 at 10:30 AM) shows an MC at 10% at ground level at 69° temperature. It is clear that the remediation effort has worked too well as the MC has transitioned from 99% to 10%, which is below the standard MC value for cement.

It should be noted from the above description of the moisture content readings 612 that the moisture content around dry walls A and E, and floor F, is much higher than other areas represented on the moisture map. It should also be clear that once the MC of a particular surface or wall has reach the standard MC, remediation efforts can be stopped for that particular floor or wall, if possible to do so without effecting remediation efforts at other floors and walls that are not at standard MCs. The water damage mitigation contractor can use the moisture map 601, the dry standards 610, and the moisture readings 612 to effectively assess and adjust remediation efforts.

A few additional characteristics of the moisture map 601 and the moisture readings 612 need to be briefly stated. Initially the moisture map 601 and moisture readings 612 can be uploaded from the job site by any remote water mitigation management client device 111, 113. The moisture map 601 provides each moisture point a separate letter such that each moisture point can be individually tracked in the moisture readings 612. As indicated above, the moisture readings 612 indicate the inches above the floor at which each MC reading is taken and indicates the temperature at that location. The list of moisture readings 612 for each moisture point only present readings actually taken, and each list expands as more readings are entered to reduce the size of the review area to only what is needed. Lastly, if the temperature at a moisture point at which a moisture reading is taken is within 5 degrees of the dew point for the respective chamber, a warning is provide, typically in the form of the temperature reading turning red in color.

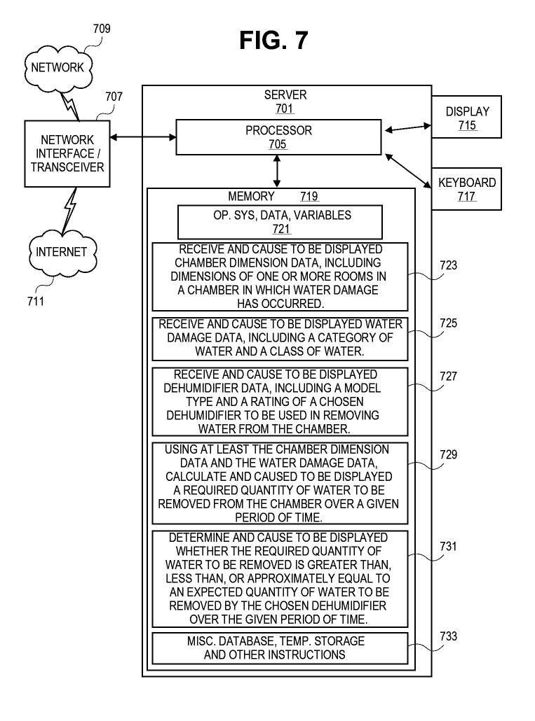

Tuning now to FIG. 7, a block diagram illustrating a water damage mitigation management server 701 configured to implement water damage mitigation management functionality, is discussed and described. The water damage mitigation management server 701 may include a transceiver 707, a processor 705, a memory 719, a display mechanism 715, and a keypad and/or touch screen 717. The transceiver 707 may be equipped with a network interface that allows the water damage mitigation management server 701 to communicate with other devices in an enterprise or other network 709 or over the Internet 711. Alternatively, the network interface may be provided in separate component coupled with the transceiver 707.

The processor 705 may comprise one or more microprocessors and/or one or more digital signal processors. The memory 719 may be coupled to the processor 705 and may comprise a read-only memory (ROM), a random-access memory (RAM), a programmable ROM (PROM), and/or an electrically erasable read-only memory (EEPROM). The memory 719 may include multiple memory locations for storing, among other things, an operating system, data and variables 721 for computer programs executed by the processor 705.

The computer programs cause the processor 705 to operate in connection with various functions as now described. A displaying chamber dimension data function 723 causes the processor 705 to receive and cause to be displayed chamber dimension data, including dimensions of one or more rooms in a chamber in which water damage has occurred. A displaying water damage data function 725 causes the processor 705 to receive and cause to be displayed water damage data, including a category of water and a class of water. A displaying dehumidifier data function 727 causes the processor 705 to receive and cause to be displayed dehumidifier data, including a model type and a rating of a chosen dehumidifier to be used in removing water from the chamber. A calculating a required quantity of water to be removed function 729 causes the processor 705 to, using at least the chamber dimension data and the water damage data, calculate and caused to be displayed a required quantity of water to be removed from the chamber over a given period of time. Lastly, a determining a comparative relation between the required quantify of water to be removed and expected quantity of water to be removed function 731 causes the processor 705 to determine and cause to be displayed whether the required quantity of water to be removed is greater than, less than, or approximately equal to an expected quantity of water to be removed by the chosen dehumidifier over the given period of time.

The above describe functions stored as computer programs may be stored, for example, in ROM or PROM and may direct the processor 705 in controlling the operation of the water damage mitigation management server 701. The memory 719 can additionally store a miscellaneous database and temporary storage 733 for storing other data and instructions, not specifically mentioned herein.

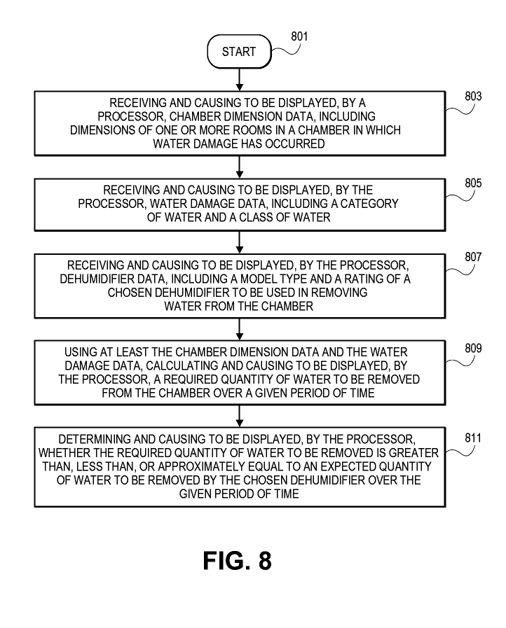

Referring now to FIG. 8, a flow chart illustrating a water damage mitigation management method is discussed and described. The water damage mitigation management method is advantageously implemented in a water damage mitigation management server that comprises a transceiver, an electronic data storage, and a processor. When water damage occurs, the method begins 801.

The method comprises receiving and causing to be displayed 803, by the processor, chamber dimension data, including dimensions of one or more rooms in a chamber in which water damage has occurred. The method further comprises receiving and causing to be displayed 805, by the processor, water damage data, including a category of water and a class of water. The method also comprises receiving and causing to be displayed 807, by the processor, dehumidifier data, including a model type and a rating of a chosen dehumidifier to be used in removing water from the chamber. The method lastly comprises determining and causing to be displayed 809, by the processor, whether the required quantity of water to be removed is greater than, less than, or approximately equal to an expected quantity of water to be removed by the chosen dehumidifier over the given period of time.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A water damage mitigation management server comprising:
a transceiver operable to transmit and receive communications over at least a portion of a network;
an electronic data storage; and
a processor cooperatively operable with the transceiver and the electronic data storage, the processor being configured to
receive and cause to be displayed
chamber dimension data, including dimensions of one or more rooms in a chamber in which water damage has occurred,
water damage data, including a category of water and a class of the water, which defines a type of damage that has occurred in the chamber, and
dehumidifier data, including a model type and a rating of a chosen dehumidifier to be used in removing water from the chamber;
using at least the chamber dimension data and the water damage data, calculate and caused to be displayed a required quantity of water to be removed from the chamber over a given period of time; and
determine and cause to be displayed whether the required quantity of water to be removed is greater than, less than, or approximately equal to an expected quantity of water to be removed by the chosen dehumidifier over the given period of time.

2. The water damage mitigation management server according to claim 1, wherein:
the chamber dimension data further includes a flooring type for each of the one or more rooms and a number of wet walls for each of the one more rooms.

3. The water damage mitigation management server according to claim 1, wherein the processor is further configured to:
determine and cause to be displayed an initial number of air movers needed to achieve the required quantity of water to be removed from the chamber over the given period of time.

4. The water damage mitigation management server according to claim 3, wherein the processor is further configured to
receive and cause to be displayed respective measurements of temperature and relative humidity taken substantially at a particular time of various locations including an outside location that is exterior to the chamber, an affected area inside the chamber, an unaffected area inside the chamber, and inside an HVAC system in the chamber, and
using the respective measurements of temperature and relative humidity, calculate and cause to be displayed respective values of grains of water per pound of air (GPP), actual vapor pressure, and dew point for each of the outside location, the affected area, the unaffected area, and inside the HVAC system.

5. The water damage mitigation management server according to claim 4, wherein the processor is further configured to
receive and cause to be displayed measurements of temperature and relative humidity provided substantially at the particular time by the chosen dehumidifier, and
using the measurements of temperature and relative humidity provided by the chosen dehumidifier at the particular time, calculate and cause to be displayed grains of water per pound of air (GPP), actual vapor pressure, and dew point at the chosen dehumidifier.

6. The water damage mitigation management server according to claim 5, wherein
the electronic data storage is configured to store normal moisture content data, which is the content of water occurring naturally a material, for a plurality of different materials; and
the processor is further configured to receive, and cause to be displayed, moisture map arrangement data which includes a map demonstrating a geographic position of each floor and each wall in each room in the chamber, an identifying label for each floor and each wall in each room in the chamber, and a material of which each floor and each wall in each room in the chamber is made.

7. The water damage mitigation management server according to claim 6, wherein the processor is further configured to
receive the following taken at substantially the particular time:
an actual moisture content measurement of each floor and each wall in each room in the chamber,
a height measurement of the height off the ground at which each actual moisture content measurement is taken, and
a temperature measurement of the room where each respective moisture content measurement is taken; and
associate and cause to be displayed the actual moisture content, height measurement, and temperature measurement of each floor and each wall in each room in the chamber with their respective identifying labels.

8. The water damage mitigation management server according to claim 7, wherein the processor is further configured to
repeatedly receive and cause to be displayed, at additional particular times, moisture content measurements, height measurements, and temperature measurements of each floor and each wall in each room in the chamber until an actual moisture content of each floor and each wall in each room in the chamber corresponds to its normal moisture content, given the material of which each floor and each wall in each room in the chamber is made.

9. A water damage mitigation management method, implemented in a water damage mitigation management server comprising a transceiver, an electronic data storage, and a processor cooperatively operable with the transceiver and the electronic data storage, the method comprising:
receiving and causing to be displayed, by the processor,
chamber dimension data, including dimensions of one or more rooms in a chamber in which water damage has occurred,
water damage data, including a category of water and a class of the water, and
dehumidifier data, including a model type and a rating of a chosen dehumidifier to be used in removing water from the chamber;
using at least the chamber dimension data and the water damage data, calculating and causing to be displayed, by the processor, a required quantity of water to be removed from the chamber over a given period of time; and
determining and causing to be displayed, by the processor, whether the required quantity of water to be removed is greater than, less than, or approximately equal to an expected quantity of water to be removed by the chosen dehumidifier over the given period of time.

10. The water damage mitigation management method according to claim 9, wherein:
the chamber dimension data further includes a flooring type for each of the one or more rooms and a number of wet walls for each of the one more rooms.

11. The water damage mitigation management method according to claim 9, further comprising:
determining and causing to be displayed, by the processor, an initial number of air movers needed to achieve the required quantity of water to be removed from the chamber over the given period of time.

12. The water damage mitigation management method according to claim 11, further comprising:
receiving and causing to be displayed, by the processor, respective measurements of temperature and relative humidity taken substantially at a particular time of various locations including an outside location that is exterior to the chamber, an affected area inside the chamber, an unaffected area inside the chamber, and inside an HVAC system in the chamber, and
using the respective measurements of temperature and relative humidity, calculating and causing to be displayed, by the processor, respective values of grains of water per pound of air (GPP), actual vapor pressure, and dew point for each of the outside location, the affected area, the unaffected area, and inside the HVAC system.

13. The water damage mitigation management method according to claim 12, further comprising:
receiving and causing to be displayed, by the processor, measurements of temperature and relative humidity provided substantially at the particular time by the chosen dehumidifier, and
using the measurements of temperature and relative humidity provided by the chosen dehumidifier at the particular time, calculating and causing to be displayed, by the processor, grains of water per pound of air (GPP), actual vapor pressure, and dew point at the chosen dehumidifier.

14. The water damage mitigation management method according to claim 13, further comprising:
storing, by the electronic data storage, normal moisture content data, which is the content of water occurring naturally a material, for a plurality of different materials; and
receiving and causing to be displayed, by the processor, moisture map arrangement data which includes a map demonstrating a geographic position of each floor and each wall in each room in the chamber, an identifying label for each floor and each wall in each room in the chamber, and a material of which each floor and each wall in each room in the chamber is made.

15. The water damage mitigation management method according to claim 14, further comprising
receiving, by the processor, the following taken at substantially the particular time:
an actual moisture content measurement of each floor and each wall in each room in the chamber,
a height measurement of the height off the ground at which each actual moisture content measurement is taken, and
a temperature measurement of the room where each respective moisture content measurement is taken; and
associating and causing to be displayed, by the processor, the actual moisture content, height measurement, and temperature measurement of each floor and each wall in each room in the chamber with their respective identifying labels.

16. The water damage mitigation management method according to claim 15, further comprising:
repeatedly receiving and causing to be displayed, by the processor, at additional particular times, moisture content measurements, height measurements, and temperature measurements of each floor and each wall in each room in the chamber until an actual moisture content of each floor and each wall in each room in the chamber corresponds to its normal moisture content, given the material of which each floor and each wall in each room in the chamber is made.

17. A non-transitory computer-readable storage medium with instructions stored thereon, that when executed by a sever computer, comprising a transceiver, an electronic data storage, and processor cooperatively operable with the transceiver and the electronic data storage, cause the server computer to perform a water damage mitigation management method comprising:
receiving and causing to be displayed, by the processor,
chamber dimension data, including dimensions of one or more rooms in a chamber in which water damage has occurred,
water damage data, including a category of water and class of water, and
dehumidifier data, including a model type and a rating of a chosen dehumidifier to be used in removing water from the chamber;
using at least the chamber dimension data and the water damage data, calculating and causing to be displayed, by the processor, a required quantity of water to be removed from the chamber over a given period of time; and
determining and causing to be displayed, by the processor, whether the required quantity of water to be removed is greater than, less than, or approximately equal to an expected quantity of water to be removed by the chosen dehumidifier over the given period of time.

18. The computer-readable storage medium according to claim 17, wherein:
the chamber dimension data further includes a flooring type for each of the one or more rooms and a number of wet walls for each of the one more rooms.

19. The computer-readable storage medium according to claim 17, wherein the water damage mitigation management method further comprises:
determining and causing to be displayed, by the processor, an initial number of air movers needed to achieve the required quantity of water to be removed from the chamber over the given period of time.

20. The computer-readable storage medium according to claim 19, wherein the water damage mitigation management method further comprises:
receiving and causing to be displayed, by the processor, respective measurements of temperature and relative humidity taken substantially at a particular time of various locations including an outside location that is exterior to the chamber, an affected area inside the chamber, an unaffected area inside the chamber, and inside an HVAC system in the chamber, and
using the respective measurements of temperature and relative humidity, calculating and causing to be displayed, by the processor, respective values of grains of water per pound of air (GPP), actual vapor pressure, and dew point for each of the outside location, the affected area, the unaffected area, and inside the HVAC system.

21. The computer-readable storage medium according to claim 20, wherein the water damage mitigation management method further comprises:
receiving and causing to be displayed, by the processor, measurements of temperature and relative humidity provided substantially at the particular time by the chosen dehumidifier, and
using the measurements of temperature and relative humidity provided by the chosen dehumidifier at the particular time, calculating and causing to be displayed, by the processor, grains of water per pound of air (GPP), actual vapor pressure, and dew point at the chosen dehumidifier.

22. The computer-readable storage medium according to claim 21, wherein the water damage mitigation management method further comprises:
storing, by the electronic data storage, normal moisture content data, which is the content of water occurring naturally a material, for a plurality of different materials; and
receiving and causing to be displayed, by the processor, moisture map arrangement data which includes a map demonstrating a geographic position of each floor and each wall in each room in the chamber, an identifying label for each floor and each wall in each room in the chamber, and a material of which each floor and each wall in each room in the chamber is made.

23. The computer-readable storage medium according to claim 22, wherein the water damage mitigation management method further comprises:
receiving, by the processor, the following taken at substantially the particular time:
an actual moisture content measurement of each floor and each wall in each room in the chamber,
a height measurement of the height off the ground at which each actual moisture content measurement is taken, and
a temperature measurement of the room where each respective moisture content measurement is taken; and
associating and causing to be displayed, by the processor, the actual moisture content, height measurement, and temperature measurement of each floor and each wall in each room in the chamber with their respective identifying labels.

24. The computer-readable storage medium according to claim 23, wherein the water damage mitigation management method further comprises:
repeatedly receiving and causing to be displayed, by the processor, at additional particular times, moisture content measurements, height measurements, and temperature measurements of each floor and each wall in each room in the chamber until an actual moisture content of each floor and each wall in each room in the chamber corresponds to its normal moisture content, given the material of which each floor and each wall in each room in the chamber is made.
